(19) United States
(12) Patent Application Publication
(10) Pub. No.: US 2016/0345369 A1
(43) Pub. Date: Nov. 24, 2016

(54) Interface Establishment between Access Nodes of Different Radio Access Technologies

(71) Applicant: TELEFONAKTIEBOLAGET LM ERICSSON (PUBL), Stockholm (SE)

(72) Inventors: Filip Mestanov, Sollentuna (SE); Tomas Hedberg, Stockholm (SE); Oumer Teyeb, Solna (SE); Jari Vikberg, Järna (SE)

(21) Appl. No.: 15/115,194

(22) PCT Filed: Jan. 31, 2014
(86) PCT No.: PCT/SE2014/050130

§ 371 Date: Jul. 28, 2016

(51) Int. Cl. H04W 76/02; H04W 8/26; H04W 48/16

(52) U.S. Cl. CPC H04W 76/022; H04W 48/16; H04W 8/26; H04W 84/042

(57) ABSTRACT

The present disclosure relates to a method performed in a first access node in a wireless network of establishing a communications interface between the first access node arranged to operate according to a first radio access technology and one or more second access nodes arranged to operate according to a second radio access technology. The one or more second access nodes are discovered (S31) based on receipt of respective radio signals representative of each second access node. A second access node of the discovered one or more second access nodes is selected (S32) for establishing a communications interface with. A transport address is derived (S33) for the selected second access node from a node related identity retrieved in the radio signal and an interface setup request message is sent (S34) to the selected second access node. The communications interface is established upon receipt (S35) of an interface setup response message from the selected second access node.

### TECHNICAL FIELD

The present disclosure relates to a method of establishing a communications interface between a first access node arranged to operate according to a first radio access technology and one or more second access nodes arranged to operate according to a second radio access technology.

The disclosure also relates to an access node arranged to operate according to a first radio access technology and configured to establish a communications interface to one or more other access nodes arranged to operate according to a second radio access technology.

### BACKGROUND

3GPP Long Term Evolution, LTE, is the fourth-generation mobile communication technologies standard developed within the 3rd Generation Partnership Project, 3GPP, to improve the Universal Mobile Telecommunication System, UMTS, standard to cope with future requirements in terms of improved services such as higher data rates, improved efficiency, and lowered costs. The Universal Terrestrial Radio Access Network, UTRAN, is the radio access network of a UMTS and Evolved UTRAN, E-UTRAN, is the radio access network of an LTE system. The Evolved UMTS Terrestrial Radio Access Network (E-UTRAN) consists of base stations called enhanced NodeBs (eNBs or eNodeBs), providing the E-UTRA user plane and control plane protocol terminations towards the UE. The eNBs are interconnected with each other by means of the X2 interface. The eNBs are also connected by means of the S1 interface to the Evolved Packet Core, EPC.

The eNB hosts functionalities such as Radio Resource Management, RRM, radio bearer control, admission control, header compression of user plane data towards serving gateway, routing of user plane data towards the serving gateway.

Today user equipments, such as mobile phones, typically support other wireless technologies such as Wireless Local Area Networks, commonly referred to as WLAN, in addition to the cellular standards. As a means to improve the network capacity in future networks, WLAN is intended to be an integral part. That is, WLAN will be regarded as just another radio access technology, so that handover can be made to WLAN without the user noticing that the service is no longer being carried by 3GPP technologies like WCDMA or LTE. Mobile operators are today mainly using WLAN to offload traffic from the mobile networks but the opportunity to improve end user experience regarding performance is also becoming more important. The current WLAN deployments are basically totally separate from mobile networks, and are to be seen as non-integrated. The usage of WLAN is driven due to the free and wide unlicensed spectrum, and the increased availability of WLAN in mobile terminals like smart phones and tablets. The end users are also becoming more and more at ease with using WLAN for example at offices and homes.

Presently, there is insufficient coordination and control of the combined cellular and WLAN network, due to that the WLAN network is still not sufficiently tightly integrated with the cellular network. Improved WLAN integration with the cellular network is emerging as a good way to improve the end user experience further.

### SUMMARY

It is an object of the present disclosure to provide embodiments solving the problem of integrating access nodes arranged to operate according to a second radio access technology, e.g. WLAN, with access nodes arranged to operate according to a first radio access technology, e.g. E-UTRA, and to introduce direct and dynamic information exchange between the first access node and the one or more second access nodes.

In particular, it is an object of the disclosure to provide embodiments establishing a direct communications interface between one or more second radio access nodes and a first radio access node, thus providing for a full integration of the second radio access nodes toward a first radio access network.

This object is achieved by a method performed in an access node, an access node configured to perform the method and a computer program run in the access node.

The disclosure presents a method embodiment performed in a first access node in a wireless network of establishing a communications interface between the first access node arranged to operate according to a first radio access technology, RAT and one or more second access nodes arranged to operate according to a second radio access technology. The one or more second access nodes are discovered based on receipt of respective radio signals representative of each second access node. A second access node of the discovered one or more second access nodes is selected for establishing a communications interface with. A transport address is derived for the selected second access node from a node related identity retrieved in the radio signal and an interface setup request message is sent to the selected second access node. The communications interface is established upon receipt of an interface setup response message from the selected second access node.

The disclosed method of establishing the communications interface provides for a method that is applicable both for establishment initiated by a WLAN node and establishment initiated by a cellular network node. Furthermore, the disclose method enables a dynamic discovery of the nodes to which the communications interface is to be established. With the disclosed dynamic discovery, additional communications interfaces may be established as soon as an additional node has been included in the network, thereby providing for improved coordination and control of a network, even when the network is subject of reconfigurations.

In accordance with an aspect of the disclosed method, the step of discovering one or more second access nodes comprises interception by the first access node of radio signals originating from respective second access nodes.

Enabling direct discovery of second access nodes arranged to operate according to a second access technology in the first access node, provides the advantage that an access node, upon introduction into a network environment, is able to commence the procedure of establishing a communications interface as soon as the node has been powered up.

In accordance with an aspect of the disclosed method, the step of discovering one or more second access nodes comprises receipt of one or more user equipment reports from a user equipment within a coverage area of the first access node. Each user equipment report is generated in response to interception by the user equipment of radio signals originating from a respective second access node.

Discovery based on user equipment reporting provides an alternative way of discovering the nodes of a network that does not require additional radio units or radio transceiver functionality of the radio access node. Thus, such a procedure could be implemented for establishing communication interfaces for present network deployments.

In accordance with an aspect of the disclosed method, the interface setup request message includes a node related identity of the first access node.

The unique identity included in the interface setup request message simplifies the process of establishing the communications interface in that a relationship is then provided between the transport address, as deducible in the transport layer, and the node identifier.

In accordance with a further aspect of the disclosed method, the first access node is an access point of a local area network and the selected second access node is an access node of a cellular radio access network.

In accordance with a further aspect of the disclosed method, the first access node is an access node of a cellular access network and the selected second access node is an access point of a local area network.

Accordingly, the communications interface may be initiated by either a WLAN node or by a cellular access node, e.g. upon introduction into an existing network configuration including a cellular access network.

In accordance with a further aspect of the disclosure, the interface setup request message includes a list of additional local area network access points within the coverage area of the selected second access node, the list including node related identities and transport addresses of the additional local area network access points.

In accordance with a further aspect of the disclosed method, the interface setup response message includes a list of access nodes configured to operate according to the second radio access technology and neighboring the selected second radio access node.

The lists included in the interface setup request message and/or the interface setup response message enable immediate set up of additional communications without the need for discovery and selection.

In accordance with an aspect of the disclosed method, the node related identity retrieved in the radio signal is a physical cell ID, PCI, or/and a cell global identity, CGI, or global cell ID, GCID.

In accordance with an aspect of the disclosed method the node related identity of the first access node is a Service Set ID, SSID, an Extended Service Set ID, ESSID, or a Basic Service Set ID, BSSID.

In accordance with another aspect of the disclosed method, the node related identity of the first access node is a physical cell ID, PCI, or/and a cell global identity, CGI, or a global cell ID, GCID.

In accordance with a further aspect of the disclosed method, the cellular access network is a GSM or a WCDMA or an LTE radio access network.

In accordance with an aspect of the disclosed method, the transport address is derived from a look-up table in a cellular radio access network, in a core network entity or in an operation and maintenance function of a cellular access network.

In accordance with an aspect of the disclosure communications interfaces are established between the first access node and a selection of second access nodes within a coverage area of the first access node.

In accordance with an aspect of the disclosure communications interfaces are established between the first access node and all second access nodes in a coverage area of the first access node.

In accordance with an aspect communications interfaces are established between the first access node and a selection of second access nodes within respective coverage areas of one or more neighboring first access nodes.

The disclosure also presents a method embodiment performed in a second access node, arranged to operate according to a second radio access technology, in a wireless network. of establishing a communications interface to a first access node arranged to operate according to a first radio access technology, RAT. In a first step, the second access node receives an interface setup request message from the first access node. The second access node responds by sending an interface setup response message to the first access node.

The disclosure also relates to an access node embodiment. The access node is arranged to operate according to a first radio access technology in a wireless network and is configured to establish a communications interface to one or more second access nodes arranged to operate according to a second radio access technology in the wireless network. The access node comprises a first radio transceiver arranged to receive radio signals of a first radio access technology. A processor in the radio access node is arranged to discover one or more second access nodes based on receipt of respective radio signals representative of each second access node, to select a second access node of the discovered one or more second access nodes for establishing the communications interface with, and to derive a transport address for the selected second access node from a node related identity retrieved in the radio signal. A communications interface comprises a transceiver configured to transmit an interface setup request message to the selected second access node; and to receive an interface setup response message from the selected second access node.

In accordance with an aspect of the disclosure, the access node comprises a second radio transceiver arranged to receive radio signals of a second radio access technology.

In accordance with an aspect of the disclosure, the access node is an eNodeB of a cellular radio access network.

In accordance with another aspect of the disclosure, the access node is an access point of a Wi-Fi local area network.

The present disclosure also presents a computer program, comprising computer readable code which, when run in an access node causes the access node to perform the disclosed method.

The access node and computer program each display advantages corresponding to the advantages already described in relation to the method performed in the access node.

### BRIEF DESCRIPTION OF THE DRAWINGS

The present technique will be more readily understood through the study of the following detailed description of the embodiments/aspects together with the accompanying drawings, of which:

FIG. 1 schematically illustrates a cellular communication network including WLAN cells;

FIG. 2 is a signaling diagram illustrating an exchange of setup messages between a first radio access node and a second radio access node for setting up a communications interface;

FIG. 3 is a flowchart schematically illustrating embodiments of method steps performed in an access node;

FIG. 4 is a block diagram schematically illustrating an access node for performing the method steps.

It should be added that the following description of the embodiments is for illustration purposes only and should not be interpreted as limiting the disclosure exclusively to these embodiments/aspects.

### DETAILED DESCRIPTION

Aspects of the present disclosure will be described more fully hereinafter with reference to the accompanying drawings. The methods and wireless device disclosed herein can, however, be realized in many different forms and should not be construed as being limited to the aspects set forth herein. Like numbers in the drawings refer to like elements throughout.

The general object or idea of embodiments of the present disclosure is to address at least one or some of the disadvantages with the prior art solutions described above as well as below. The various steps described below in connection with the figures should be primarily understood in a logical sense, while each step may involve the communication of one or more specific messages depending on the implementation and protocols used.

The terminology used herein is for the purpose of describing particular aspects of the disclosure only, and is not intended to limit the disclosure to any particular embodiment. As used herein, the singular forms “a”, “an” and “the” are intended to include the plural forms as well, unless the context clearly indicates otherwise.

It is an object of the present disclosure to provide embodiments solving the problem of integrating access nodes arranged to operate according to a second radio access technology, e.g. WLAN, with access nodes arranged to operate according to a first radio access technology, e.g. E-UTRA, and to introduce direct and dynamic information exchange between the first access node and the one or more second access nodes. A basic concept involves establishing a direct communications interface between one or more second radio access nodes and a first radio access node, thus providing for a full integration of the second radio access nodes toward a core network.

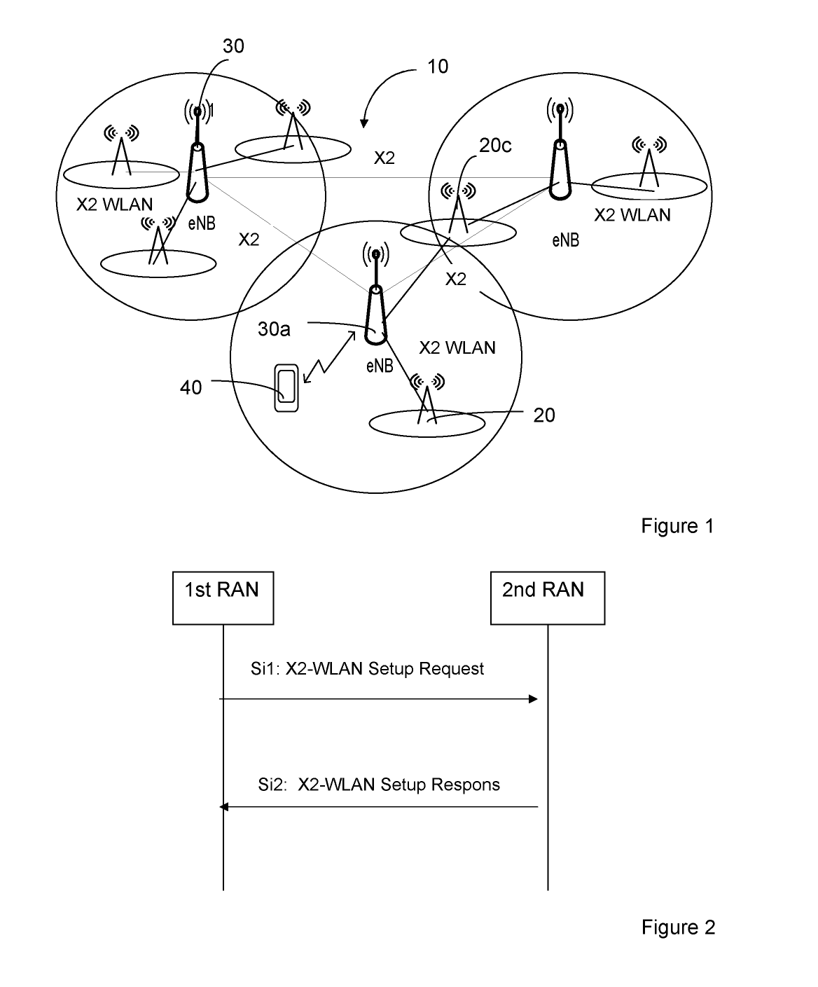

FIG. 1 schematically illustrates a cellular communication network 10. The network 10 comprises first access nodes 20, preferably configured to operate according to a wireless local area network technology, WLAN, second access nodes 30, preferably configured to operate according to a 3GPP radio access technology, 3GPP RAT and one or more user equipments, UEs 40. In the illustrated example, the first access nodes are access points, APs, operating according to WLAN and the second access nodes are eNodeBs, eNBs, operating according to 3GPP RAT. As illustrated in FIG. 1, a single eNB can be connected to multiple WLAN access points via a communications interface using methods further described in the following. In accordance with an aspect of the disclosure, an eNB will be connected to all APs within a coverage area of the eNB, i.e. within one or more cells of the eNB. In accordance with a further aspect, the eNB will be connected to APs that are partially within its coverage area, as illustrated for eNB 30a and AP 20c in FIG. 1, or belong to a neighboring cell, but are close to the cell border of the eNB.

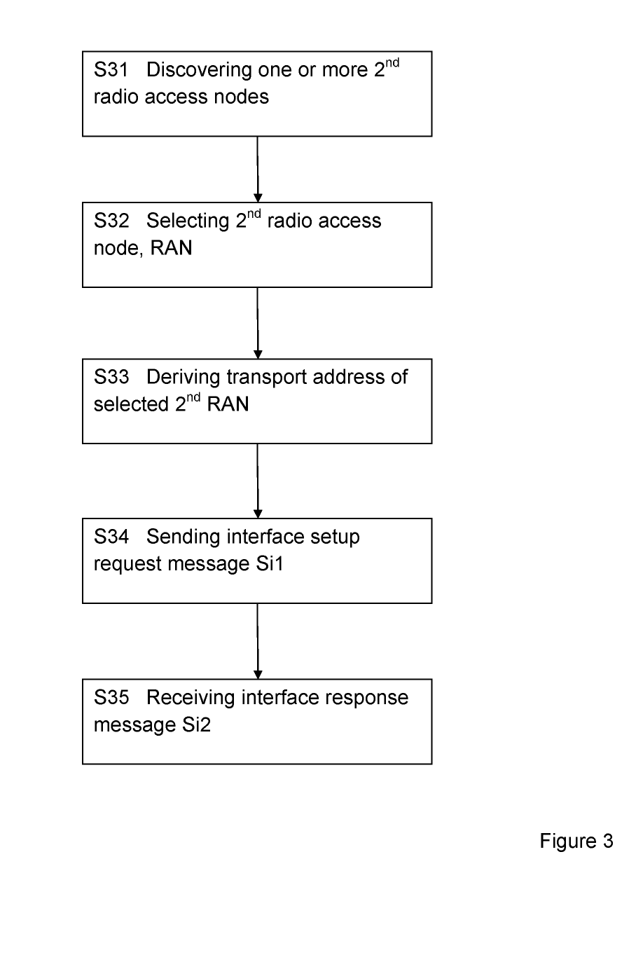

FIG. 3 is a flowchart schematically illustrating embodiments of method steps performed in a first access node in a wireless network, of establishing a communications interface between the first access node arranged to operate according to a first radio access technology, RAT, and one or more second access nodes arranged to operate according to a second radio access technology.

The first aspect in relation to establishing the communications interface, hereinafter also denominated as an X2-WLAN interface, is the discovery between the first access node and the one or more second access nodes, e.g. where the first access node is a WLAN node and the one or more second access nodes are 3GPP nodes, i.e. eNBs, or vice versa. The discovery step is very important since it is a prerequisite for the actual interface establishment.

The discovery step comprises discovering S31 one or more second access nodes based on receipt of respective radio signals representative of each second access node, i.e. a dynamic discovery.

The discovery procedure will now be described in more detailed for a scenario wherein the first access node is an access point of a local area network and the selected second access node is an access node of a cellular radio access network. The opposite scenario relating to discovery in a network deployment wherein the first access node is an access node of a cellular access network and the selected second access node is an access point of a local area network will also be described in more detail.

According to an aspect of the disclosure, the dynamic discovery is a node based dynamic discovery, wherein the step of discovering one or more second access nodes comprises interception in the first access node of radio signals originating from respective second access nodes. Interception implies receipt of a message transmitted by the second access node, e.g. as a cell broadcast message.

The first access node is equipped with a radio transceiver that is able to receive and decode radio signals according to the radio access technology of the one or more access nodes, i.e. the second radio access technology. For a scenario where the first access node is an access point, AP, arranged to operate according to WLAN and the one or more second access nodes are access nodes of a cellular radio access network, 3GPP nodes, the AP is equipped with an additional radio unit that is able to receive and decode a discovered 3GPP radio signal. The additional radio unit intercepts the 3GPP communication. For the opposite scenario where the first access node is a 3GPP node and the one or more second access nodes are access point arranged to operate according to WLAN, the 3GPP node may be equipped with a WLAN radio unit that is able to receive WLAN radio signals.

In accordance with another example embodiment of the disclosure, the dynamic discovery is a UE-based dynamic discovery, wherein the step of discovering one or more second access nodes comprises receipt of one or more user equipment reports from a user equipment within a coverage area of the first access node, each user equipment report generated in response to interception by the user equipment of radio signals originating from a respective second access node. Using this approach, the UE can report detected second access nodes to a receiving first access node. For a scenario where the first access node is a 3GPP node, i.e. an eNB, and the one or more second access nodes are WLAN access points, APs, the UE can report to the eNB APs that it detects. Reporting is performed when the UE detects an AP, encounters an AP with a signal level above a predetermined level, upon explicit report requests from the eNB, according to a predetermined triggering event, periodically or according to any other similar condition. Once the eNB has received a UE reports relating to discovery of one or more APs, the step of discovering one or more second access nodes based on receipt of respective radio signals representative of each second access node is concluded. For the opposite scenario where the first access node is a WLAN AP and the one or more second access points are access nodes of a cellular radio access network, 3GPP nodes, the UE could be configured to do the opposite and provide reports on discovered eNBs to a receiving WLAN AP.

In an alternative, the step of discovering the second access nodes comprises receipt of access node environment reports based on prior knowledge stored in the wireless communication network, e.g. in an O&M system of the network. The step of discovering one or more second radio access nodes, then involves receiving details on said one or more second radio access node from the O&M system. For a scenario where an additional WLAN access point is introduced into the network and needs to set up an interface with one or more eNBs in the network, the AP would connect to the O&M system at initial power ON. If the AP is aware of its location such details will be submitted to the O&M system, if the AP is not aware of its location, discovery is possible by submission of its unique network identifier. The O&M system, being aware of the relation between unique network identifier and deployment location, could then derive the location of the AP. The O&M system, being also aware of the 3GPP nodes deployment location makes the relation between the AP and eNB locations and based on this information contacts either node, whereby the first access node discovers the one or more second access nodes.

When powering up an access point introduced into the coverage area of an eNB, the AP listens to cell broadcast messages. Upon discovery of one or more second access nodes by the first access nodes a selection step is performed whereby the first access nodes selects S32 a second access node of the discovered one or more second access nodes for establishing relations with, i.e. an communication interface.

In a next step, the first access node derives S33 a transport address, IP-address, for the selected second access node from a node related identity retrieved in the radio signal.

This step implies, e.g. for the previously mentioned node-based dynamic discovery, that the access point listens to cell broadcast messages and derives, for each selected eNB a Physical Cell ID, PCI, and/or a cell global identity, CGI, or global cell ID, GCID, of the eNB cell that it should establish relationships. Once the AP collects the node related identities of the eNB cells, it will need to relate those identifiers to actual network transport addresses (e.g., IP addresses) that can be used to establish the X2-WLAN interface. The network transport addresses can be derived by either:
Communication with an O&M system;
Employing a lookup function in the network. One example is to use a DNS-based approach in which the AP for example combines the PCI and the Public Land Mobile Network, PLMN,-ID to an unique Fully Qualified Domain Name, FQDN, and retrieves the transport address, IP-address, of the eNB (or other RAN node) from a DNS server.
An alternative to this approach is for the eNB to include its transport address in the cell broadcast message. In that way the AP, after having intercepted a cell broadcast messages, could directly initiate the establishment of the X2-WLAN interface with the respective eNB.

In most cases the transport address of the eNB is rather sensitive information that should preferably be prevented from exposure to third parties. Since the DNS protocol does not provide any privacy or data protection, it would be beneficial if additional security considerations were taken into account so that the transport address is processed via some security mechanisms that would allow only the designated entities to be able to successfully read it. Such security mechanism could for example be:
Opening a secure tunnel (e.g., IPSec, SSL/TLS, etc.) between the AP and the DNS server before performing the DNS lookup so that the DNS lookup messages are protected by means of the secure tunnel;
Encrypting either or both of the FQDN (send by the AP to the DNS server) and the transport address (usually an IPv4/IPv6 address send by the DNS server) so that even in situations where no secure tunnel between the AP and the DNS server exists, clear-text information exchange is prevented. Methods of encryption may include: symmetric key encryption (AES, DES, RC4, etc.), public key encryption, two-way hashing functions, etc.

The above disclosed security mechanisms are applicable to the case when the transport address is obtained by a network lookup function. However, if the transport address is broadcasted by the eNB, the second security mechanism is applicable.

Using the previously disclosed UE-based dynamic discovery, the UE reports detected second access nodes to a receiving first access node. Following a selection of a discovered node for establishment of communications interface, the first access node derives a transport address for the selected second access node from a node related identity retrieved by the UE and included in the reporting. The procedure of determining the transport address follows the previously disclosed case—it can be either by polling an O&M system or any other lookup function. In addition, it is possible for the UE to discover the access nodes transport address (e.g., via ANQP procedures or some other means) and then include that transport address in the report. The same security mechanisms that were described for the node-based dynamic discovery in order to protect the confidentiality of the transport address could also be employed here.

As previously mentioned, the UE:s could also be configured to report a node related identity of an eNB to a receiving WLAN AP which then has the ability to map the physical cell identity, PCI, to a transport address.

When the first access node has derived a transport address for the selected second access node, the next step is the sending S34 of an interface setup request message Sit to the selected second access node, as illustrated in the signaling diagram of FIG. 2.

Table 1 below illustrates an example embodiment of an interface setup request message for a scenario where the interface setup is initiated by an eNB. As illustrated below, the interface setup request message includes a node related identity of the first access node provided by the information element; the node related identity is referred to as the Global eNB ID.

TABLE 1

| | | | IE type and | Semantics | | Assigned |
|---|---|---|---|---|---|---|
| IE/Group Name | Presence | Range | reference | description | Criticality | Criticality |
| Message Type | M | | | | YES | reject |
| Global eNB ID | M | | | | YES | reject |
| Served Cells | | 1 . . . | | Complete list of | YES | reject |
| | | <maxCellineNB> | | cells served by | | |
| | | | | the eNB | | |
| >Served Cell | M | | | | — | — |
| Information | | | | | | |
| >Cellular Neighbour | | 0 . . . | | | — | — |
| Information | | <maxnoofNeighbours> | | | | |
| >>ECGI | M | | | E-UTRAN Cell | — | — |
| | | | | Global Identifier | | |
| | | | | of the neighbor | | |
| | | | | cell | | |
| >>PCI | M | | INTEGER | Physical Cell | — | — |
| | | | (0 . . . 503, . . .) | Identifier of the | | |
| | | | | neighbor cell | | |
| >>EARFCN | M | | | DL EARFCN for | — | — |
| | | | | FDD or EARFCN | | |
| | | | | for TDD | | |
| >>TAC | O | | OCTET | Tracking Area | YES | ignore |
| | | | STRING (2) | Code | | |
| >>EARFCN | O | | | DL EARFCN for | YES | reject |
| Extension | | | | FDD or EARFCN | | |
| | | | | for TDD. If this | | |
| | | | | IE is present, | | |
| | | | | the value | | |
| | | | | signaled in the | | |
| | | | | EARFCN IE is | | |
| | | | | ignored. | | |
| >WLAN Neighbour | O | 1 . . . | | List of WLAN | — | — |
| Information | | <maxWLANCellineNB> | | cells/APs within | | |
| | | | | the cell | | |
| GU Group Id List | | 0 . . . | | List of all the | GLOBAL | reject |
| | | <maxfPools> | | pools to which | | |
| | | | | the eNB belongs | | |
| >GU Group Id | M | | | | — | — |

The information element, IE, ‘WLAN Neighbour information’ provides a list of second access nodes within a coverage area of the initiating eNB.

Table 2 below illustrates an example of an interface setup request message for a scenario where the interface setup is initiated by a WLAN AP. As illustrated below, the interface setup request message includes a node related identity of the first access node given by the information element, IE, ‘WLAN cell ID’, providing the identity of the initiating WLAN AP, SSID or BSSID.

TABLE 2

| | | | IE type and | Semantics | | Assigned |
|---|---|---|---|---|---|---|
| IE/Group Name | Presence | Range | reference | description | Criticality | Criticality |
| Message Type | M | | | | YES | reject |
| WLAN cell ID | M | | | ID of the | YES | reject |
| | | | | WLAN cell | | |
| | | | | (SSID/BSSID) | | |
| >Cellular | | 0 . . . | | | — | — |
| Neighbour | | <maxnoofNeighbours> | | | | |
| Information | | | | | | |
| >>ECGI | M | | | E-UTRAN Cell | — | — |
| | | | | Global | | |
| | | | | Identifier of | | |
| | | | | the neighbor | | |
| | | | | cell | | |
| >>PCI | M | | INTEGER | Physical Cell | — | — |
| | | | (0 . . . 503, . . .) | Identifier of | | |
| | | | | the neighbor | | |
| | | | | cell | | |
| >>EARFCN | M | | | DL EARFCN | — | — |
| | | | | for FDD or | | |
| | | | | EARFCN for | | |
| | | | | TDD | | |
| >>TAC | O | | OCTET | Tracking Area | YES | ignore |
| | | | STRING (2) | Code | | |
| >>EARFCN | O | | | DL EARFCN | YES | reject |
| Extension | | | | for FDD or | | |
| | | | | EARFCN for | | |
| | | | | TDD. If this IE | | |
| | | | | is present, the | | |
| | | | | value signaled | | |
| | | | | in the EARFCN | | |
| | | | | IE is ignored. | | |

Now turning back to FIG. 3. In a concluding step S35, following the interface setup request, an interface setup response message Si2 is received whereby a communications interface is finalized between the first access node and the selected access node. The interface establishment is thereby completed. The established interface provides improved ability to coordinate and control the combined cellular and WLAN network by enabling direct IP-communication between access nodes of the cellular network through the newly established X2-WLAN interface. The disclosed method is performed for each second access node selected for interface establishment.

From a perspective of the second access node to which the communications interface is to be established, the interface establishment procedure is initiated upon receipt of a Interface setup request Si1, also denominated X2-WLAN Setup Request, from the first access node. The second access node responds to the received interface setup request Si1 by sending an interface setup response message Sit, also denominated X2-WLAN Setup Response.

In accordance with an aspect of the disclosure, the interface setup request message and/or the interface setup response message include one or more list of additional local area network access points within the coverage area of the selected second access node or neighboring cellular access nodes, the list including node related identities and transport addresses of the additional local area network access points or neighboring access nodes.

The one or more lists of additional local area network access points and/or neighboring cellular access nodes enable immediate set up of additional communications interfaces to the additional local area network access points without the need for discovery and selection of the additional nodes.

Table 3 below illustrates an example of an interface setup response message, wherein the response message is a response by a WLAN AP.

TABLE 3

| | | | IE type and | Semantics | | Assigned |
|---|---|---|---|---|---|---|
| IE/Group Name | Presence | Range | reference | description | Criticality | Criticality |
| Message Type | M | | | | YES | reject |
| WLAN cell ID | M | | | ID of the | YES | reject |
| | | | | WLAN cell | | |
| | | | | (SSID/BSSID) | | |
| >Cellular | | 0 . . . | | | — | — |
| Neighbour | | <maxnoofNeighbours> | | | | |
| Information | | | | | | |
| >>ECGI | M | | | E-UTRAN Cell | — | — |
| | | | | Global | | |
| | | | | Identifier of | | |
| | | | | the neighbor | | |
| | | | | cell | | |
| >>PCI | M | | INTEGER | Physical Cell | — | — |
| | | | (0 . . . 503, . . .) | Identifier of | | |
| | | | | the neighbor | | |
| | | | | cell | | |
| >>EARFCN | M | | | DL EARFCN | — | — |
| | | | | for FDD or | | |
| | | | | EARFCN for | | |
| | | | | TDD | | |
| >>TAC | O | | OCTET | Tracking Area | YES | ignore |
| | | | STRING (2) | Code | | |
| >>EARFCN | O | | | DL EARFCN | YES | reject |
| Extension | | | | for FDD or | | |
| | | | | EARFCN for | | |
| | | | | TDD. If this IE | | |
| | | | | is present, the | | |
| | | | | value signaled | | |
| | | | | in the EARFCN | | |
| | | | | IE is ignored. | | |

The information element, IE, ‘WLAN cell ID’ provides the identity of the responding WLAN AP.

Table 4 below illustrates an example of a setup response message, when the response is received from an eNB, i.e., when the selected second access node is an eNB and the interface establishment is performed by a WLAN AP.

TABLE 4

| | | | IE type and | Semantics | | Assigned |
|---|---|---|---|---|---|---|
| IE/Group Name | Presence | Range | reference | description | Criticality | Criticality |
| Message Type | M | | | | YES | reject |
| Global eNB ID | M | | | | YES | reject |
| Served Cells | | 1 . . . | | Complete list | YES | reject |
| | | <maxCellineNB> | | of cells served | | |
| | | | | by the eNB | | |
| >Served Cell | M | | | | — | — |
| Information | | | | | | |
| >Cellular | | 0 . . . | | | — | — |
| Neighbour | | <maxnoofNeighbours> | | | | |
| Information | | | | | | |
| >>ECGI | M | | | E-UTRAN Cell | — | — |
| | | | | Global | | |
| | | | | Identifier of | | |
| | | | | the neighbor | | |
| | | | | cell | | |
| >>PCI | M | | INTEGER | Physical Cell | — | — |
| | | | (0 . . . 503, . . .) | Identifier of | | |
| | | | | the neighbor | | |
| | | | | cell | | |
| >>EARFCN | M | | | DL EARFCN | — | — |
| | | | | for FDD or | | |
| | | | | EARFCN for | | |
| | | | | TDD | | |
| >>TAC | O | | OCTET | Tracking Area | YES | ignore |
| | | | STRING (2) | Code | | |
| >>EARFCN | O | | | DL EARFCN | YES | reject |
| Extension | | | | for FDD or | | |
| | | | | EARFCN for | | |
| | | | | TDD. If this IE | | |
| | | | | is present, the | | |
| | | | | value signaled | | |
| | | | | in the EARFCN | | |
| | | | | IE is ignored. | | |
| >WLAN | O | 1 . . . | | List of WLAN | — | — |
| Neighbour | | <maxWLANCellineNB> | | cells/APs | | |
| Information | | | | within the cell | | |
| GU Group Id List | | 0 . . . | | List of all the | GLOBAL | reject |
| | | <maxfPools> | | pools to | | |
| | | | | which the | | |
| | | | | eNB belongs | | |
| >GU Group Id | M | | | | — | — |

Information element, IE, ‘WLAN Neighbour information’ provides a list of WLAN AP:s or cells within a coverage area of the eNB providing the response.

An example of the contents of a WLAN neighbor information element that is used in the setup request and response messages is shown below. The table lists the contents for one WLAN neighbor cell, and thus the request/response messages may contain such a list for each neighbor. The maximum number of list entries is limited by the maxWLANCellineNB parameter.

TABLE 5

| | | | IE type and | Semantics | | Assigned |
|---|---|---|---|---|---|---|
| IE/Group Name | Presence | Range | reference | description | Criticality | Criticality |
| Message Type | | | ENUMERATED(detailed, | Tells if the WLAN | | |
| | | | summarize) | info is detailed one | | |
| | | | | for each WLAN | | |
| | | | | AP/cell or a | | |
| | | | | summarized version | | |
| PCI | | 6 | OCTETS | BSSID | — | — |
| BSSIDs | | 1 . . . | | Broadcast BSSIDs | — | — |
| | | <maxnoofBSSIDs> | | | | |
| >BSSID | | 6 | OCTETS | | — | — |
| >Capabilities | | 2 | OCTETS | | | |
| >>ESS | | 1 | BIT-FIELD | ESS indication | | |
| >>IBSS | | 1 | BIT-FIELD | IBSS indication | | |
| >>CF Pollable | | 1 | BIT-FIELD | | | |
| >>CF-Poll | | 1 | BIT-FIELD | | | |
| request | | | | | | |
| >>Privacy | | 1 | BIT-FIELD | Indicates | | |
| | | | | requirement for | | |
| | | | | data confidentiality | | |
| >>Short | | 1 | BIT-FIELD | Indicates the use of | | |
| Preamble | | | | a short preamble | | |
| >>PBCC | | 1 | BIT-FIELD | Indicates support | | |
| | | | | for Packet Binary | | |
| | | | | Convolutional Code | | |
| >>Channel | | 1 | BIT-FIELD | Indicates whether | | |
| Agility | | | | Channel Agility is in | | |
| | | | | use | | |
| >>Spectrum | | 1 | BIT-FIELD | Indicates | | |
| mgmt. | | | | requirement for | | |
| | | | | spectrum | | |
| | | | | management | | |
| >>QoS | | 1 | BIT-FIELD | Value set according | | |
| | | | | to Table 8-35 [5] | | |
| >>Short Slot | | 1 | BIT-FIELD | Indicates support | | |
| Time | | | | for short slot time | | |
| >>APSD | | 1 | BIT-FIELD | Indicates support | | |
| | | | | for Automatic | | |
| | | | | Power Save | | |
| | | | | Delivery | | |
| >>Radio | | 1 | BIT-FIELD | Indicates support | | |
| Measurement | | | | for radio | | |
| | | | | measurements | | |
| >>DSSS- | | 1 | BIT-FIELD | Indicates the use of | | |
| OFDM | | | | DSSS-ODFM | | |
| >>Delayed | | 1 | BIT-FIELD | Indicates support | | |
| Block Ack | | | | for delayed block | | |
| | | | | acknowledgement | | |
| >>Immediate | | 1 | BIT-FIELD | Indicates support | | |
| Block Ack | | | | for immediate block | | |
| | | | | acknowledgement | | |
| >Service Set | | 2 . . . | OCTETS | | | |
| Identifier (SSID) | | 34 | | | | |
| >Supported | | 3 . . . | OCTETS | | | |
| Rates | | 10 | | | | |
| >Frequency- | | 7 | OCTETS | | | |
| hopping (FH) | | | | | | |
| Parameter Set | | | | | | |
| >DSSS | | 3 | OCTETS | | | |
| Parameter Set | | | | | | |
| >CF Parameter | | 8 | OCTETS | | | |
| Set | | | | | | |
| >IBSS | | 4 | OCTETS | | | |
| Parameter Set | | | | | | |
| >Traffic | | 6 . . . | OCTETS | | | |
| Indication Map | | 256 | | | | |
| (TIM) | | | | | | |
| >Country | | 8 . . . | OCTETS | | | |
| | | 256 | | | | |
| >FH Pattern | | 4 | OCTETS | | | |
| Parameters | | | | | | |
| >FH Pattern | | 6 . . . | OCTETS | | | |
| Table | | 256 | | | | |
| >Power | | 3 | OCTETS | | | |
| Constraint | | | | | | |
| >Channel | | 5 | OCTETS | | | |
| Switch | | | | | | |
| Announcement | | | | | | |
| >Quiet | | 8 | OCTETS | | | |
| >IBSS DFS | | 10 . . . | OCTETS | | | |
| | | 255 | | | | |
| >TPC Report | | 4 | OCTETS | | | |
| >ERP | | 3 | OCTETS | | | |
| >Extended | | 3 . . . | OCTETS | | | |
| Supported | | 257 | | | | |
| Rates | | | | | | |
| >RSN | | 256 | OCTETS | | | |
| >BSS Load | | 7 | OCTETS | | | |
| >EDCA | | 20 | OCTETS | | | |
| Parameter Set | | | | | | |
| >QoS Capability | | 3 | OCTETS | | | |
| >AP Channel | | 3 . . . | OCTETS | | | |
| Report | | 257 | | | | |
| >BSS Average | | 3 | OCTETS | | | |
| Access Delay | | | | | | |
| >Antenna | | 3 | OCTETS | | | |
| >BSS Available | | 4 . . . | OCTETS | | | |
| Admission | | 28 | | | | |
| Capacity | | | | | | |
| >BSS AC Access | | 6 | OCTETS | | | |
| Delay | | | | | | |
| >Measurement | | 3 . . . | OCTETS | | | |
| Plot | | 257 | | | | |
| Transmission | | | | | | |
| >Multiple BSSID | | 3 . . . | OCTETS | | | |
| | | 257 | | | | |
| >RM Enabled | | 7 | OCTETS | | | |
| Capabilities | | | | | | |
| >Mobility | | 5 | OCTETS | | | |
| Domain | | | | | | |
| >DSE | | 22 | OCTETS | | | |
| Registered | | | | | | |
| Location | | | | | | |
| >Extended | | 6 | OCTETS | | | |
| Channel Switch | | | | | | |
| Announcement | | | | | | |
| >Supported | | 4 . . . | OCTETS | | | |
| Operating | | 255 | | | | |
| Classes | | | | | | |
| >HT | | 28 | OCTETS | | | |
| Capabilities | | | | | | |
| >HT Operation | | 24 | OCTETS | | | |
| >20/40 BSS | | 3 | OCTETS | | | |
| Coexistence | | | | | | |
| >Overlapping | | 16 | OCTETS | | | |
| BSS Scan | | | | | | |
| Parameters | | | | | | |
| >Extended | | 3 . . . | OCTETS | | | |
| Capabilities | | 8 | | | | |
| >FMS | | 3 . . . | OCTETS | | | |
| Descriptor | | 257 | | | | |
| >QoS Traffic | | 3 . . . | OCTETS | | | |
| Capability | | 5 | | | | |
| >Time | | 3 . . . | OCTETS | | | |
| Advertisement | | 18 | | | | |
| >Interworking | | 3, 5, 9, 11 | OCTETS | | | |
| >Advertisement | | VARIABLE | | | | |
| Protocol | | | | | | |
| >Roaming | | VARIABLE | | | | |
| Consortium | | | | | | |
| >Emergency | | 10 | OCTETS | | | |
| Alert Identifier | | | | | | |
| >Mesh ID | | 2 . . . | OCTETS | | | |
| | | 34 | | | | |
| >Mesh | | 9 | OCTETS | | | |
| Configuration | | | | | | |
| >Mesh Awake | | 4 | OCTETS | | | |
| Window | | | | | | |
| >Beacon Timing | | 3 . . . | OCTETS | | | |
| | | 255 | | | | |
| >MCCAOP | | 8 | OCTETS | | | |
| Advertisement | | | | | | |
| Overview | | | | | | |
| >MCCAOP | | 4 . . . | OCTETS | | | |
| Advertisement | | 257 | | | | |
| >Mesh Channel | | 8 | OCTETS | | | |
| Switch | | | | | | |
| Parameters | | | | | | |
| >HS 2.0 | | | | Indication for HS | | |
| Indication | | | | 2.0 support | | |
| Element | | | | | | |
| >>Element ID | | 1 | OCTETS | | | |
| >>Length | | 1 | OCTETS | | | |
| >>OI | | 3 | OCTETS | | | |
| >>Type | | 1 | OCTETS | | | |
| >>Hotspot | | 1 | OCTETS | | | |
| Configuration | | | | | | |
| >>>DGAF | | 1 | BIT-FIELD | | | |
| Disabled | | | | | | |
| >>>PPS MO | | 1 | BIT-FIELD | | | |
| ID Present | | | | | | |
| >>>ANQP | | 1 | BIT-FIELD | | | |
| Domain ID | | | | | | |
| Present | | | | | | |
| >>>Reserved | | 1 | BIT-FIELD | | | |
| >>>Release | | 4 | BIT-FIELD | | | |
| Number | | | | | | |
| >>PPS MO ID | | 2 | OCTETS | | | |
| >>ANQP | | 2 | OCTETS | | | |
| Domain ID | | | | | | |
| >AP Location | | | | GPS coordinates or | | |
| | | | | other location | | |
| | | | | information | | |
| >Vendor | | 3 . . . | OCTETS | | | |
| Specific | | 257 | | | | |

The above table is an example and contains most of the currently available WLAN capabilities for the sake of completeness. Only a subset is required for establishing a communications interface in accordance with the present disclosure.

Some of the more notable parameters among the ones enlisted above are the following:

ESSID—the Extended Service Set Identifier of which the WLAN AP is part. The ESS comprises one or multiple interconnected BSSs (WLAN APs), which are appear as one logical entity to any UE/WLAN terminal) connected to any of the underlying BSSs;

AP Location—GPS coordinates or other location information related to the position of the WLAN AP;

Operating frequency (channel number)—indicates the frequency at which the AP operates by either explicitly signaling the frequency or pointing to a channel number. Note that a single AP can operate on several frequencies/channels simultaneously;

BSS Load—it contains information on the current UE/WLAN terminal population and traffic levels in the WLAN AP;

HS 2.0 Indication Element—provides Hotspot 2.0 related information (HS 2.0 revision compliance, etc.).

It should also be noted that the above information can also be communicated in a summarized fashion. For example, instead of telling the detailed information of every AP, the provided information could be in the form of “There are x APs that support these capabilities”.

The list of WLAN cells/APs sent during the establishment of the X2-WLAN interface can be used in several ways:

If a certain AP under the coverage of an eNB is aware of other APs within the coverage of the same eNB, the list of WLAN APs enables discovery in order to establish relations with those APs.

The disclosure has presented a method of establishing a communications interface between a first access node and a second access node, e.g. a 3GPP node and a WLAN node. The method could naturally be performed for all second access nodes within a coverage area of the first access node, a selection of second access nodes within the coverage area or a selection of second access nodes within a respective coverage area of one or more neighboring first access nodes.

In the examples above, the cellular network has been exemplified with a 3GPP LTE network. However, the disclosure is not limited to a specific cellular technology. The disclosed method is also applicable in radio access nodes arranged to operate in accordance with GSM, WCDMA or future standards.

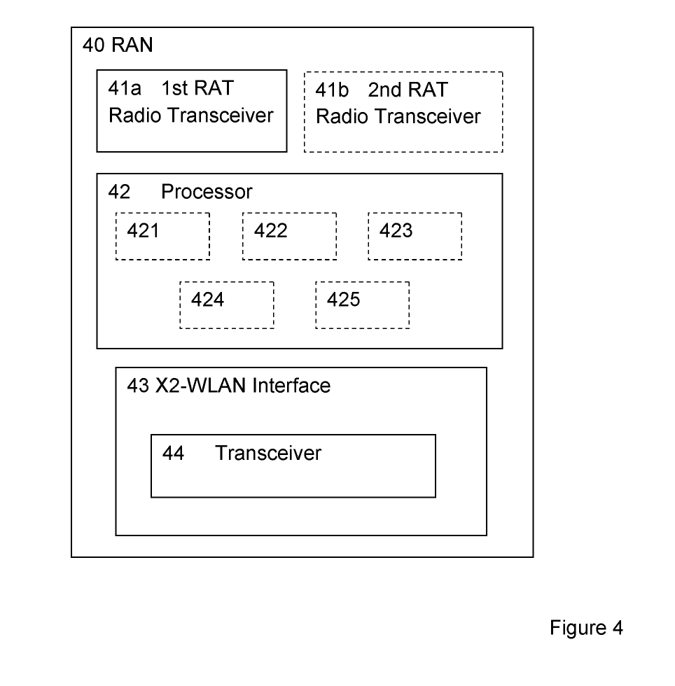

FIG. 4 discloses a block diagram schematically illustrating an access node 40 for performing the method steps. The access node 40 is configured to establish a communications interface to one or more second access nodes arranged to operate according to a second radio access technology in the wireless network. The access node 40 comprises a first radio transceiver 41a, processor 42 and a communications interface 43. The first radio transceiver 41a is arranged to receive radio signals of a first radio access technology. The processor 42 is arranged to discover, using the first radio transceiver one or more second access nodes based on receipt of respective radio signals representative of each second access node, to select a second access node of the discovered one or more second access nodes for establishing the communications interface with, and to derive a transport address for the selected second access node from a node related identity retrieved in the radio signal. A communications interface 43 of the access node includes a transceiver 44 configured to transmit an interface setup request message to the selected second access node; and to receive an interface setup response message from the selected second access node.

In accordance with an aspect of the disclosure, the radio access node further comprises a second radio transceiver 41b arranged to arranged to receive radio signals of a second radio access technology.

In accordance with the previous disclosure of the method performed in the access node, the access node is either an access node of a cellular radio access network, e.g. an eNodeB, or an access point of a local area network, e.g. a WLAN.

As previously mentioned, the disclosure also relates to a computer program comprising computer readable code which, when run in an access node causes the access node to perform the disclosed methods. When running the above-mentioned computer readable code in the processor 42 of the radio access node 40, it causes the access node 40 to receive, using the first radio transceiver, radio signals of a first radio access technology and to discover, using the first radio transceiver one or more second access nodes based on receipt of respective radio signals representative of each second access node. Interface setup request messages and response messages are exchanged with a selected second radio access node for which a transport address is derived.

According to one aspect of the disclosure, the processor comprises one or several of:
a discovery module 421 configured to discover one or more second access nodes based on receipt of respective radio signals representative of each second access node;
selection module 422 configured to select a second access node of the discovered one or more second access nodes for establishing a communications interface with;
an address deriving module 423 configured to derive a transport address for the selected second access node from a node related identity retrieved in the radio signal;
an interface setup request module configured to generate an interface setup request message for transmission to the selected second access node; and
an interface setup response module arranged to establish the communications interface based on the received interface setup response message.

1-22. (canceled)

23. A method, performed in a first access node in a wireless network, of establishing a communications interface between the first access node, arranged to operate according to a first radio access technology (RAT), and one or more second access nodes arranged to operate according to a second radio access technology, the method comprising:
discovering one or more second access nodes based on receipt of respective radio signals representative of each second access node;
selecting a second access node of the discovered one or more second access nodes for establishing a communications interface with;
deriving a transport address for the selected second access node from a node-related identity retrieved in the radio signal;
sending an interface setup request message to the selected second access node; and
receiving an interface setup response message from the selected second access node.

24. The method of claim 23, wherein the step of discovering one or more second access nodes comprises intercepting, by the first access node, radio signals originating from respective second access nodes.

25. The method of claim 23, wherein the step of discovering one or more second access nodes comprises receiving of one or more user equipment reports from a user equipment within a coverage area of the first access node, each user equipment report generated in response to interception by the user equipment of radio signals originating from a respective second access node.

26. The method of claim 23, wherein the step of discovering one or more second access nodes comprises determining a node-related identity of each discovered one or more second access node.

27. The method of claim 23, wherein the interface setup request message includes a node-related identity of the first access node.

28. The method of claim 23, wherein the first access node is an access point of a local area network and the selected second access node is an access node of a cellular radio access network.

29. The method of claim 28, wherein the interface setup request message includes a list of additional local area network access points within the coverage area of the selected second access node, the list including node-related identities and transport addresses of the additional local area network access points.

30. The method of claim 28, wherein the node-related identity retrieved in the radio signal is a physical cell ID (PCI) or/and a global cell ID (GCID).

31. The method of claim 30, wherein the node-related identity of the first access node is a Service Set ID (SSID), an Extended Service Set ID (ESSID), or a Basic Service Set ID (BSSID).

32. The method of claim 28, wherein the interface setup response message includes a list of access nodes configured to operate according to the second radio access technology and neighboring the selected second radio access node.

33. The method of claim 23, wherein the first access node is an access node of a cellular access network and the selected second access node is an access point of a local area network.

34. The method of claim 33, wherein the node-related identity retrieved in the radio signal is a Service Set ID (SSID), an Extended Service Set ID (ESSID), or a Basic Service Set ID (BSSID).

35. The method of claim 34, wherein the node-related identity of the first access node is a physical cell ID (PCI) or/and a global cell ID (GCID).

36. The method of claim 23, wherein the cellular access network is a GSM or a WCDMA or an LTE radio access network.

37. The method of claim 23, wherein the transport address is derived from a look-up table in a cellular radio access network, a core network entity or in an operation and maintenance function of a cellular access network.

38. The method of claim 23, wherein communications interfaces are established between the first access node and a subset or all of the second access nodes in a coverage area of the first access node.

39. A method, performed in a second access node, arranged to operate according to a second radio access technology, in a wireless network, of establishing a communications interface to a first access node arranged to operate according to a first radio access technology (RAT), the method comprising the steps of:
receiving an interface setup request message from the first access node; and
sending an interface setup response message to the first access node.

40. An access node arranged to operate according to a first radio access technology in a wireless network, said access node being configured to establish a communications interface to one or more second access nodes arranged to operate according to a second radio access technology in the wireless network, the access node comprising:
a first radio transceiver arranged to receive radio signals of a first radio access technology;
a processor arranged to discover one or more second access nodes based on receipt of respective radio signals representative of each second access node, to select a second access node of the discovered one or more second access nodes for establishing the communications interface with, and to derive a transport address for the selected second access node from a node-related identity retrieved in the radio signal; and
a communications interface including a transceiver configured to transmit an interface setup request message to the selected second access node; and to receive an interface setup response message from the selected second access node.

41. The access node of claim 40, further comprising a second radio transceiver arranged to receive radio signals of a second radio access technology.

42. The access node of claim 41, wherein the access node is an eNodeB of a cellular radio access network.

43. The access node of claim 42, wherein the access node is an access point of a Wi-Fi local area network.

44. A non-transitory computer-readable medium comprising, stored thereupon, a computer program comprising computer-readable code that, when run in a first access node in a wireless network, the first access node being arranged to operate according to a first radio access technology (RAT), causes the access node to:
discover one or more second access nodes based on receipt of respective radio signals representative of each second access node, the one or more second access nodes being arranged to operate according to a second radio access technology;
select a second access node of the discovered one or more second access nodes for establishing a communications interface with;
derive a transport address for the selected second access node from a node-related identity retrieved in the radio signal;
send an interface setup request message to the selected second access node; and
receive an interface setup response message from the selected second access node.
